(19) United States
(12) Patent Application Publication
(10) Pub. No.: US 2007/0005399 A1
(43) Pub. Date: Jan. 4, 2007

(54) Method and computer program for evaluating the sustainability of a permanent life insurance policy

(75) Inventors: Richard M. Weber, Carlsbad, CA (US); Chris Hause, Overland Park, KS (US)

Correspondence Address: HOVEY WILLIAMS LLP, 2405 GRAND BLVD., SUITE 400, KANSAS CITY, MO, 64108, US

(73) Assignee: Ethical Edge Insurance Solutions, LLC

(21) Appl. No.: 11/172,541

(22) Filed: Jun. 30, 2005

(51) Int. Cl. G06Q 40/00

(52) U.S. Cl. 705/4

(57) ABSTRACT

A method and computer program for evaluating the sustainability of a permanent life insurance policy involves helping a user choose a type of insurance policy that is appropriate by asking the user a series of questions relating to the person's risk and management preferences. A confidence factor is determined for an insurance policy's funding premium, wherein the confidence factor indicates a probability that the policy will sustain until a user-selected age, such as the age of one hundred. The confidence factor is determined by applying parameters of the user's policy to one thousand trial illustrations developed using performance information from actual portfolios over the last forty years, and reporting a percentage of the trial illustrations that sustained through age one hundred. If the confidence factor is unacceptably low, the user adjusts the premium and/or an investment allocation scheme to generate a new confidence factor. The confidence factor can be generated for a new policy or for an in-force policy.

### BACKGROUND OF THE INVENTION

1. Field of the Invention

The present invention relates to permanent life insurance policy evaluation tools. More particularly, the invention involves a method and computer program for evaluating the sustainability of a Universal or Variable Universal Life insurance policy (and the survivorship forms of these as described below), and enabling a user to determine a type of policy and funding premium that generate an acceptable likelihood that the insurance policy will sustain through the life of the policy.

2. Description of the Prior Art

Life insurance policies have historically had fixed pricing, wherein if the policy owner paid the premium specified in the contract of insurance, the coverage was guaranteed for the life of the insured. Within the last twenty-five years, however, a new class of “indeterminate premium” life insurance policies have become very popular, although somewhat difficult for many consumers to understand. Rather than the insurer guaranteeing its contract for a fixed price, the sustainability risk is shifted to the policy owner in exchange for the flexibility to pay whatever—and whenever—the policy owner chooses. Thus, the policy owner has the responsibility to make certain that enough premium is paid into the policy to maintain a positive account balance. A positive account balance is maintained when the premiums paid into the policy plus income generated by policy assets are greater than insurance charges and expense charges debited from the policy account.

Indeterminate life insurance policies are available in various forms, including universal life (UL), variable universal life (VUL), survivorship universal life (SUL), and survivorship variable universal life (SVUL). With a universal life policy, a portion of the premiums paid by the policy owner are invested by the insurance company and generate income which is reflected in an interest credit added to the policy by the insurance company. Premiums paid plus interest credits accumulate as cash value of the policy. Cash value exists to support the death benefit of the policy, but excess cash values may be used, for example, to offset the higher cost of insurance in the later years of the policy owner's life or as supplemental retirement income. With a universal life insurance policy, the policy owner has no control over how the cash value of the policy is invested, but is typically guaranteed a minimum rate of return on the cash value.

Variable universal life policies are similar in nature to universal life policies, except that VUL policy owners control how the assets of the policy are invested, and the cash value of the policy is credited with the return or “income” generated from the investments. Thus, VUL policies give policy owners greater control over their policy but expose the policy owners to the risk of earning a minimal return on their investment or even losing money. SUL and SVUL polices are similar to UL and VUL policies, respectively, except that SUL and SVUL policies provide permanent insurance protection for two people, with the death benefit payable upon the death of the last to die of the two insured individuals.

Computerized policy illustrations are often used by insurance companies and their agents to help customers understand how indeterminate life insurance policies work and to distinguish between what is guaranteed and what is not guaranteed as the policy is credited with interest or investment earnings and premium payments from the policy owner and is debited for insurance and expense charges. U.S. Pat. No. 5,956,691, for example, discloses a system for dynamically illustrating the performance of an insurance policy wherein a user can interactively change policy variables, such as interest rates and premiums paid, and view the effect of each change on the performance of the policy.

While most UL and SUL policies have minimum interest credits, such as 3%, and all indeterminate premium policies typically have a maximum schedule of insurance and expense charges specified in the contract, insurance companies often market indeterminate life insurance policies by projecting current assumptions in the policy illustrations. In other words, the policy illustrations project an expectation of crediting an interest rate higher than the guaranteed minimum, and assessing insurance and expense charges that are less than the guaranteed maximum. Insurance companies, however, have wide latitude to change the interest credits (in UL policies) and the cost of insurance charges based on the insurance company's claims, investment returns, and profit margins, among other things. Consequently, long-term projections reflect only the specific company's straight-line assumptions based on current experience about the performance of the insurance policy. It will be appreciated that the time horizon for a young customer can be as long as one hundred years, wherein many fluctuations in the policy parameters can and will occur and errors in the policy illustrations can be compounded.

Unfortunately, such straight-line policy illustrations do not give customers a realistic sense of how much premium to pay in order to sustain the proposed insurance policy over long periods of time during which interest credits or investment returns, as well as insurance and expense charges, will frequently change. Because customers do not consider the changes in these parameters when buying the policies, they are susceptible to under-funding the policy, which will ultimately cause the insurance policy to lapse prior to the customer's death.

Accordingly, there is a need for an improved method of evaluating a life insurance policy that does not suffer from the problems and limitations of the prior art.

### SUMMARY OF THE INVENTION

The present invention solves the above-described problems and provides a distinct advance in the art of permanent life insurance policy evaluation tools. More particularly, the present invention involves a method and computer program for evaluating the sustainability of a permanent life insurance policy, wherein the method and program involve determining a likelihood that a particular life insurance policy will sustain throughout a pre-determined time period for a given premium amount.

In a first embodiment of the invention, the method comprises a first step of creating a benchmark policy by averaging policy parameters from a plurality of similar insurance policies, wherein the policy parameters include numerous elements of policy expenses. The method further comprises a second step of generating a plurality of trial illustrations using parameters of the benchmark policy, a user-specified premium amount, and performance information from a plurality of randomly-generated investment returns based on historic returns from the selected model portfolio, and calculating a percentage of the trial illustrations that sustain through a pre-determined period of time.

A second embodiment of the invention includes more user interaction. According to the second embodiment, the method involves the steps of determining a user-specified investment allocation scheme and creating a benchmark policy by averaging policy parameters from a plurality of insurance policies available on the market, wherein the policy parameters include policy expenses.

A plurality of trial illustrations are generated using parameters of the benchmark policy, a user-specified premium amount, and performance information created by generating 300-1,000 trial illustrations, each of which is based on randomly generated, historic investment returns selected from over a forty-year period, and calculating a percentage of the trial illustrations that sustain through a pre-determined period of time. The percentage of trial illustrations that sustain through a pre-determined period of time is calculated by periodically adding a premium amount and an investment income amount to each trial illustration, periodically debiting a cost of insurance amount and an expense amount from each trial illustration, and determining a percentage of trial illustrations with positive balances throughout the predetermined period of time.

A second plurality of trial illustrations are generated using a second user-specified premium amount if the percentage of trial illustrations that sustain through the pre-determined period of time is unacceptable to the user.

A third embodiment of the invention involves a method of assessing the sustainability of an in-force permanent life insurance policy. The method comprises the steps of determining an asset value and an investment allocation scheme of an in-force permanent life insurance policy, and generating a plurality of trial illustrations using expense and premium information from the in-force policy, the asset value of the in-force policy, and performance information from a plurality of randomly-selected actual portfolios presenting investment allocation schemes similar to that of the in-force policy. A percentage of the trial illustrations that sustain through a pre-determined period of time is calculated.

A fourth embodiment of the invention involves a computer-readable medium encoded with a computer program for enabling a computer to assess the sustainability of a permanent life insurance policy. The computer program comprises code segments for determining an amount of insurance commensurate with a person's needs and expectations, and for determining a type of insurance policy that is compatible with the person's risk and management preferences.

The computer program further comprises code segments for determining a funding premium that meets the person's expectations, selecting a particular life insurance company from which to purchase the life insurance policy, determining an investment strategy for a policy sub-account, and determining whether the person can fund the policy with sufficient cash value to withdraw or borrow funds to supplement retirement income.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a flowchart of steps involved in a method of evaluating the sustainability of a permanent life insurance policy according to principles of the invention;

FIG. 2 is a first portion of a computer-generated questionnaire for determining an amount of life insurance that is commensurate with a customer's needs, desires, and circumstances;

FIG. 3 is a second portion of the questionnaire of FIG. 2;

FIG. 4 is a third portion of the questionnaire of FIG. 2;

FIG. 5 is a first portion of a computer-generated report based on information received from the questionnaire of FIGS. 2-4;

FIG. 6 is a second portion of the report of FIG. 5;

FIG. 7 is a third portion of the report of FIG. 5;

FIG. 8 is a first portion of a computer-generated questionnaire for determining a level of risk with which the customer is most comfortable;

FIG. 9 is a second portion of the questionnaire of FIG. 8;

FIG. 10 is a third portion of the questionnaire of FIG. 8;

FIG. 11 is a fourth portion of the questionnaire of FIG. 8;

FIG. 12 is a fifth portion of the questionnaire of FIG. 8;

FIG. 13 is a sixth portion of the questionnaire of FIG. 8;

FIG. 14 is a flowchart of steps involved in determining a funding premium for the permanent insurance policy that meets the customer's expectations;

FIG. 15 is a first portion of a computer-generated questionnaire for assisting a user in choosing a life insurance company;

FIG. 16 is a second portion of the questionnaire of FIG. 15;

FIG. 17 is a third portion of the questionnaire of the FIG. 15;

FIG. 18 is a fourth portion of the questionnaire of FIG. 15;

FIG. 19 is the fourth portion of the questionnaire of FIG. 15 reflecting various selections indicated by a user;

FIG. 20 is a computer-generated report based on information received from the questionnaire of FIGS. 15-19; and

FIG. 21 is a computer operable to implement a computer program embodying principals of the present invention.

### DETAILED DESCRIPTION OF THE PREFERRED EMBODIMENTS

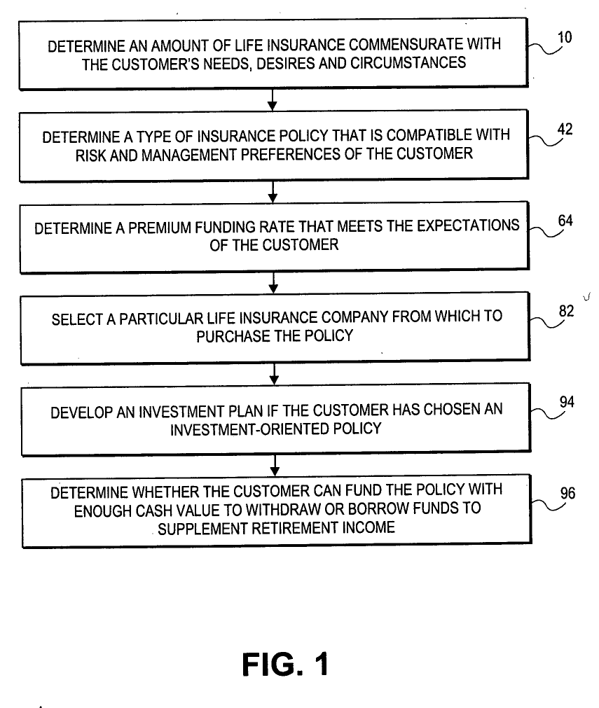

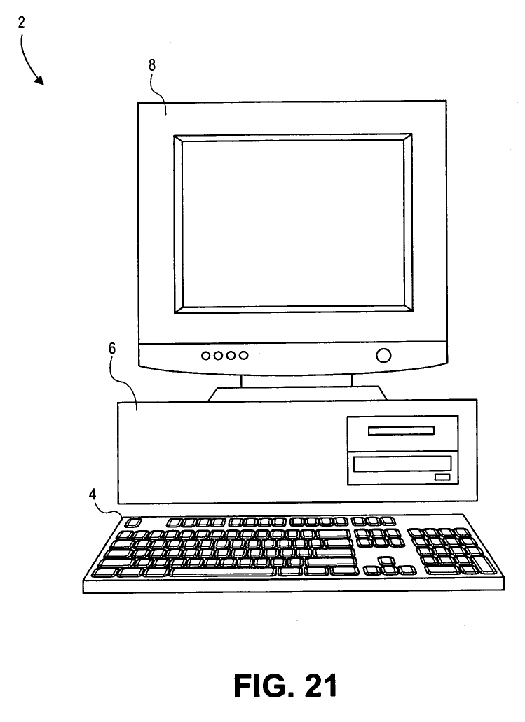

A flowchart of steps involved in a method of evaluating the sustainability of a permanent life insurance policy according to principals of the present invention is illustrated in FIG. 1. The method of the present invention is especially well-suited for being implemented on a computer or computer network, such as the computer 2 illustrated in FIG. 21 that includes a keyboard 4, a processor console 6, and a display 8. The method of the present invention will thus be generally described herein as a computer program. It will be appreciated, however, that the principals of the present invention are useful independently of a particular implementation, and that one or more of the steps described herein may be implemented without the assistance of a computer.

The present invention can be implemented in hardware, software, firmware, or a combination thereof. In a preferred embodiment, however, the invention is implemented with a computer program. The computer program and equipment described herein are merely examples of a program and equipment that may be used. to implement the present invention and may be replaced with other software and computer equipment without departing from the scope of the present invention.

The computer program of the present invention is stored in or on computer-readable medium residing on or accessible by a host computer 2 for instructing the host computer 2 to implement the method of the present invention as described herein. The computer program preferably comprises an ordered listing of executable instructions for implementing logical functions in the host computer and other computing devices coupled with the host computer. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

The ordered listing of executable instructions comprising the computer program of the present invention will hereinafter be referred to simply as “the program.” It will be understood by-one of ordinary skill in the art that the program may comprise a single list of executable instructions or two or more separate lists, and may be stored on a single computer-readable medium or multiple distinct media.

In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

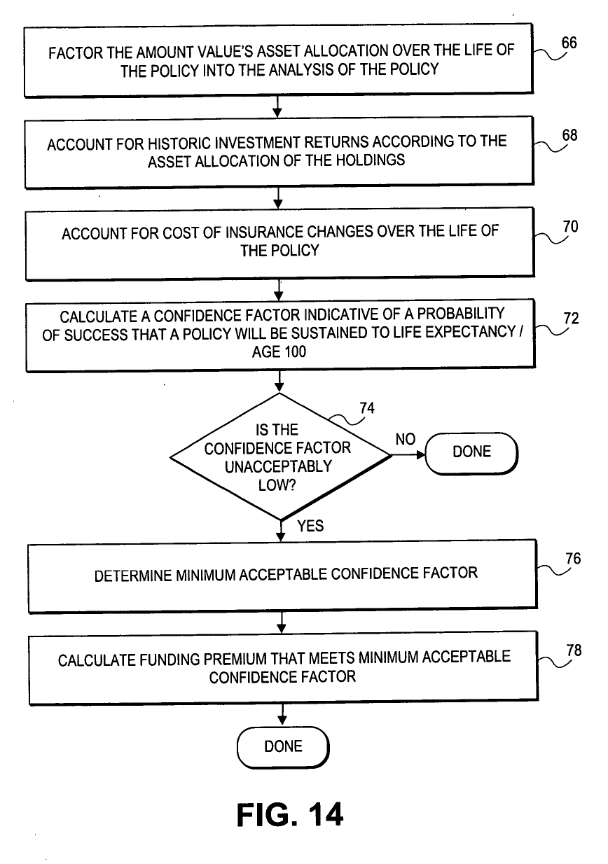

The flow charts of FIGS. 1 and 14 show the functionality and operation of a preferred implementation of the present invention in more detail. In this regard, some of the blocks of the flow charts may represent a module segment or portion of code of the computer program of the present invention which comprises one or more executable instructions for implementing the specified logical function or functions. In some alternative implementations, the functions noted in the various blocks may occur out of the order depicted in FIGS. 1 and 14. For example, two blocks shown in succession in FIG. 1 may in fact be executed substantially concurrently, or the blocks may sometimes be executed in the reverse order depending upon the functionality involved.

Referring initially to FIG. 1, an amount of life insurance that is commensurate with a customer's needs, desires, and circumstances is first determined, as depicted in block 10. More specifically, the program assists a user in determining a proper amount of life insurance by prompting the user to submit information relating to the customer's needs, desires, and circumstances and using the information to determine an appropriate amount of insurance. The “customer” is a potential purchaser of an insurance policy while the “user” is a person interacting with the program. Thus, the user may be the customer or may be a salesperson who is helping the customer choose an insurance policy.

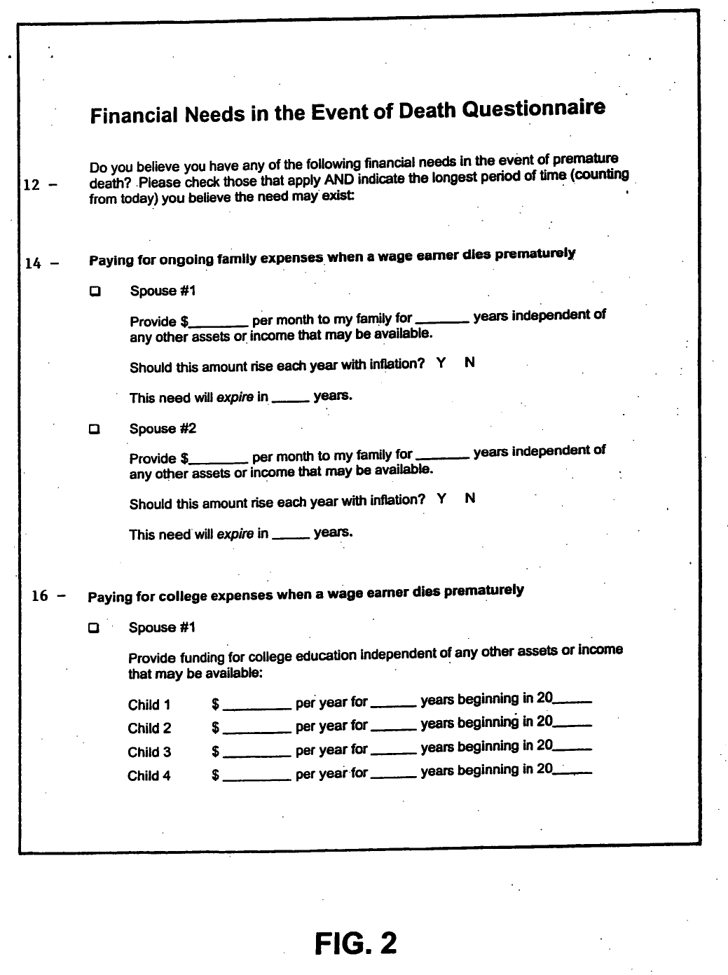

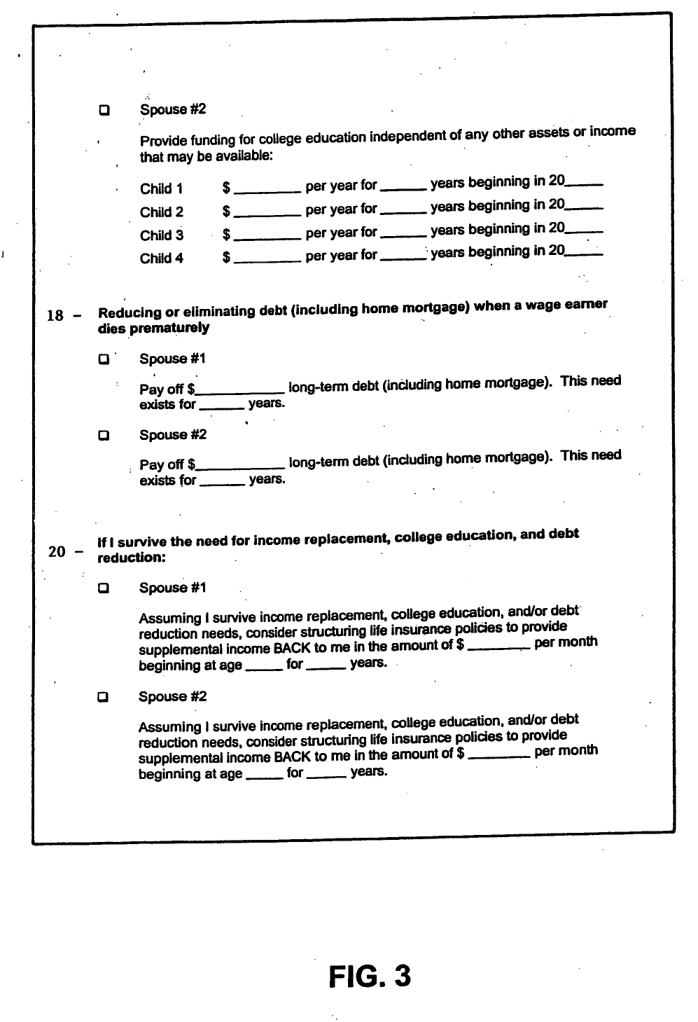

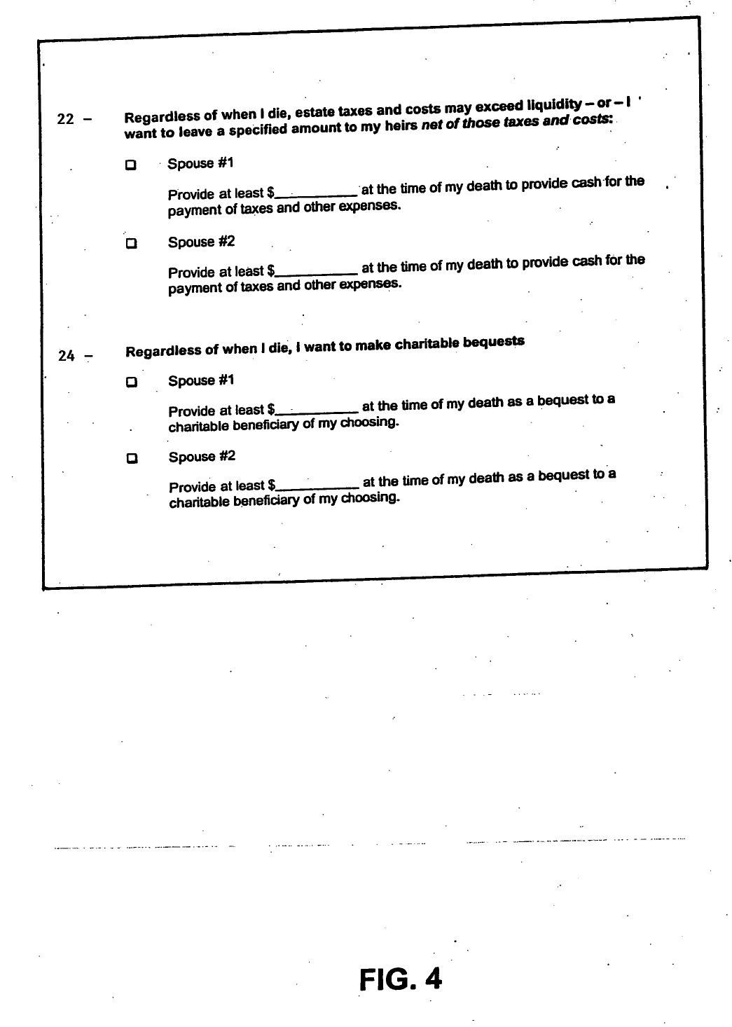

FIGS. 2-4 illustrate an exemplary online questionnaire that the program presents to the user to determine the appropriate amount of life insurance. Referring initially to FIG. 2, instructions 12 direct the user to identify financial needs the customer will have in the event of premature death and the length of time it is anticipated each need will exist. A first question 14 asks the user to submit information relating to ongoing family expenses that would need to be paid for in the event a wage earner dies prematurely. The user has the option of choosing either or both spouses and designating a monthly amount necessary to cover the monthly expenses, a number of years the monthly amount should be provided, whether the monthly amount should increase each year with inflation, and when that need will expire.

A second question 16 asks the user to submit information relating to anticipated expenses relating to higher education for each of multiple children of a first spouse and a second spouse. The illustrated questions solicit higher education expense information including an anticipated amount per year per child, in what year that expense will begin to be incurred, and for how many years it is anticipated it will last. In the illustrated questionnaire children are listed under each of a first spouse and a second spouse, thereby enabling the user to account for obligations arising from a previous marriage.

A third question 18 asks the user to submit information relating to debt that would need to be satisfied upon the premature death of a wage earner. The third question 18 solicits an amount of long-term debt as well as a number of years associated with the debt. The user can thus submit yearly payment information based on a current yearly payment schedule for one or more loan obligations. Alternatively, the customer may desire to pay off all debts simultaneously upon the premature death of a wage earner and could submit a lump sum to be paid off in one year.

A fourth question 20 relates to the customer's preferences for management of the insurance policy if the customer survives the various needs presented in the previous questions. If the customer survives higher education expenses by, for example, living until all children have graduated from college, the portion of the policy designated for higher education may be otherwise directed. The customer may desire to receive that money back in monthly installments beginning at a certain age for a certain number of years.

A fifth question 22 asks the user to determine whether the customer desires to account for a specified amount to provide cash for the payment of taxes and other costs typically incurred at death. If the taxes and other costs are not accounted for, they may reduce the value of the estate of the user and therefore reduce the portion of the estate passing to the heirs or devisees of the deceased. A sixth question 24 relates to the customer's desires to make charitable bequests.

While certain specific questions have been described and illustrated in the exemplary questionnaire, one of ordinary skill in the art will recognize that these are illustrative only and that it is within the scope of the present invention to modify or add to the illustrated questions according to the circumstances of a particular insured or group of customer.

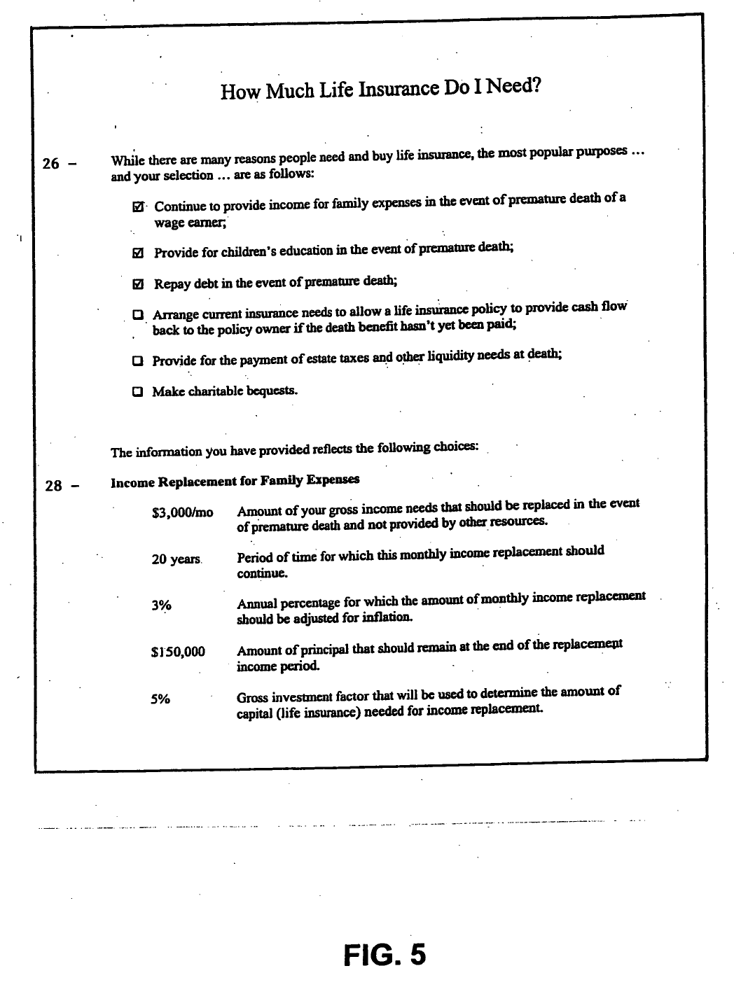

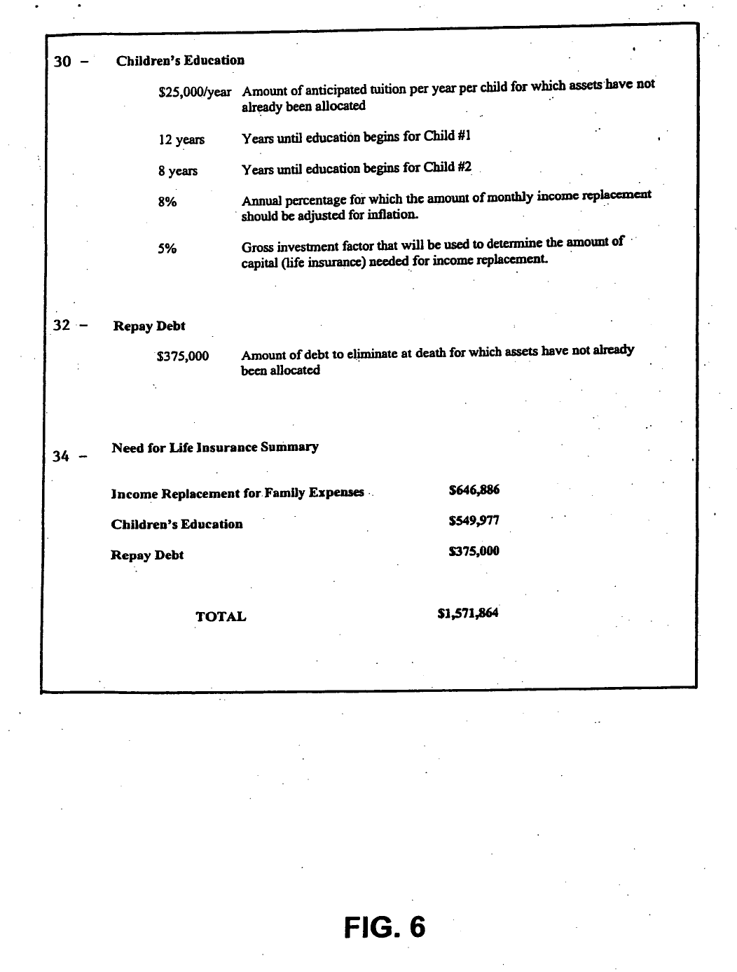

After receiving the information from the user via the questionnaire described above, the program generates a report of the information for the customer's review and verification. An exemplary report based on the information submitted by the user is illustrated in FIGS. 5 and 6, wherein the report may be in one or more of various forms including paper form and electronic form such as e-mail, HTML, or PDF. A first section 26 lists several of the most common reasons people purchase life insurance, and further indicates which of those reasons are reflected in the information submitted by the user. In the example illustrated in FIG. 5, the user's choices reflect that the insured desires to purchase life insurance for the purpose of providing for family expenses, providing for children's education, and repaying debt in the event of a premature death. The first section 26 is helpful in enabling the customer to see an overview of the types of benefits his or her choices have focused on, as well as to confirm that those choices reflect his or her true desires.

Sections 28, 30, and 32 illustrate the customer's particular allocation of policy payments. Section 28 details, among other things, an amount of monthly income that the insurance should replace in the event of premature death; a period of time over which the monthly income should be paid out; and an annual percentage of increase for inflation. Section 30 details provisions for children's education while section 32 details provisions for debts to pay off. Section 34 provides a summary of all dollar amounts with a total that represents the insured's total need for life insurance.

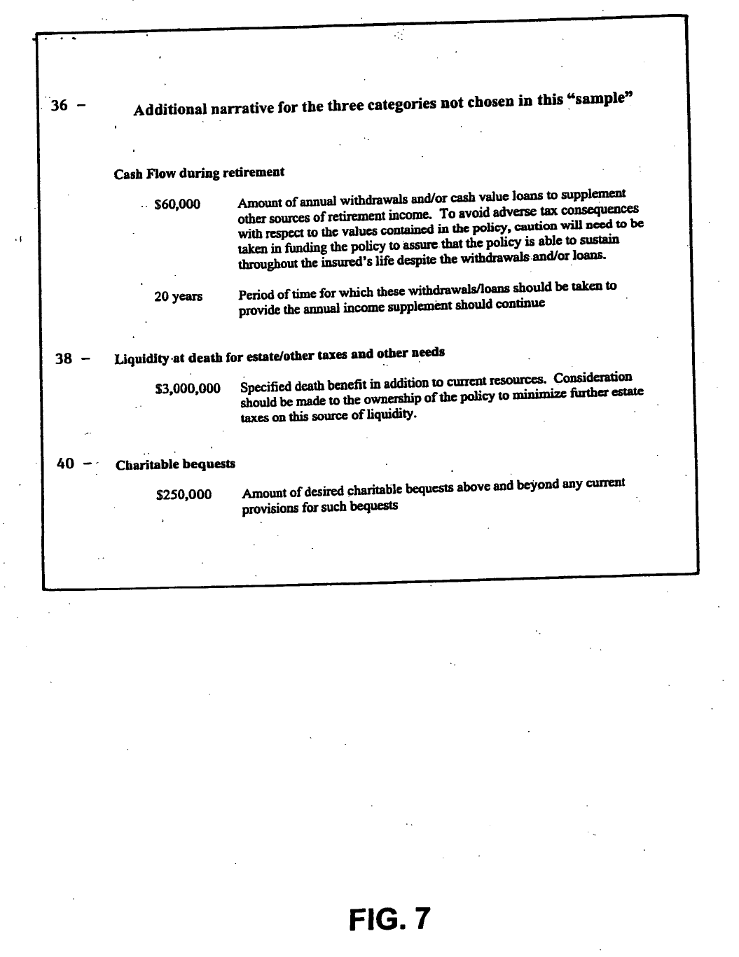

The exemplary report described above and set forth in FIGS. 5 and 6 are based on a scenario in which the customer elects not to allow the policy to provide a cash flow back to the policy owner if one or more benefits have not been paid, to provide for the payment of estate taxes and other liquidity at death, and to make charitable bequests (see FIG. 5). Exemplary sections 36,38,40 of the report corresponding to those choices are illustrated in FIG. 7.

Once the appropriate amount of life insurance has been determined, a type of life insurance policy compatible with risk and management preferences of the customer is determined, as depicted in block 42 of FIG. 1. More particularly, the program assists the user in determining a degree of control the customer desires over policy sub-accounts, and a level of risk with which the customer is comfortable. Policy sub-accounts are the investment accounts underlying the insurance policy that generate income (and, in some cases, losses) that are applied to the policy. The degree of control desired by the customer is ascertained primarily to determine whether the customer prefers to manage the sub-accounts himself or herself (VUL/SVUL), or prefers that the insurance company manage the investments underlying the policy (UL/SUL).

The degree of control the customer needs or desires is determined by presenting one or more questions to the user via a software interface (not shown). The questions may ascertain the customer's skill level and experience in making investment decisions; the customer's desire to exercise control over the investment of the sub-account; and the customer's desire to insulate the sub-account from the success/failure of the insurance company. Furthermore, the questions may determine a length of time the customer intends the policy to be in force—which will typically depend on the customer's age. For each type of insurance, for example, there is a policy recommendation based on the need being for fifteen years or less or more than fifteen years. The questions presented by the software interface may be similar in form and layout to the questions illustrated in FIGS. 2-4.

Based on the customer's answers to these questions, the program determines that the customer either prefers a policy with a customer-managed sub-account (VUL or SVUL) or a policy with a company-managed account (UL or SUL). If the customer indicates that he or she has a high level of investment experience and a strong desire to exercise control over the sub-account assets, for example, the program matches the customer with a VUL or SVUL insurance policy.

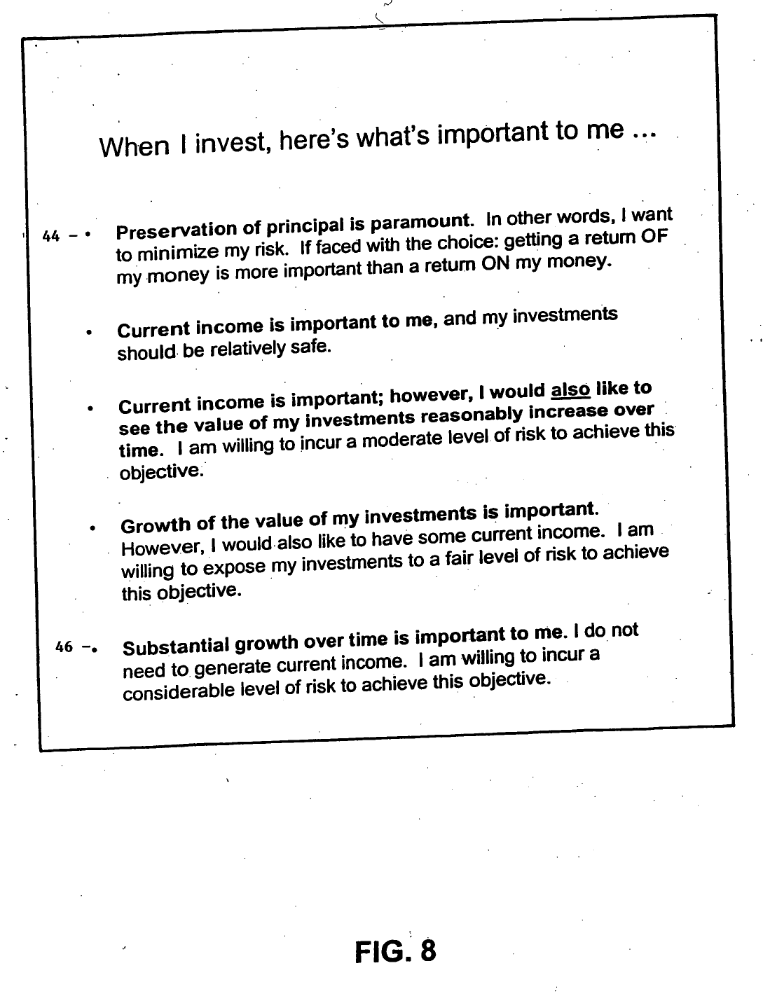

To determine a level of risk the customer is comfortable with, the program prompts the user to answer a series of questions intended to determine the customer's comfort level with various portfolios, each presenting varying degrees of risk. A first set of questions is illustrated in FIG. 8, wherein the user can indicate which of the scenarios is most important by clicking on an indicator to the left of the scenario. If preserving principal by minimizing risk is most important to the customer, the “Preservation of principal is paramount” option 44 is chosen. If fast growth with greater risk is most important to the customer, the “Substantial growth over time is important to me” option 46 is chosen. Thus, option 46 presents a greater degree of risk than option 44, and the options therebetween represent varying degrees of risk.

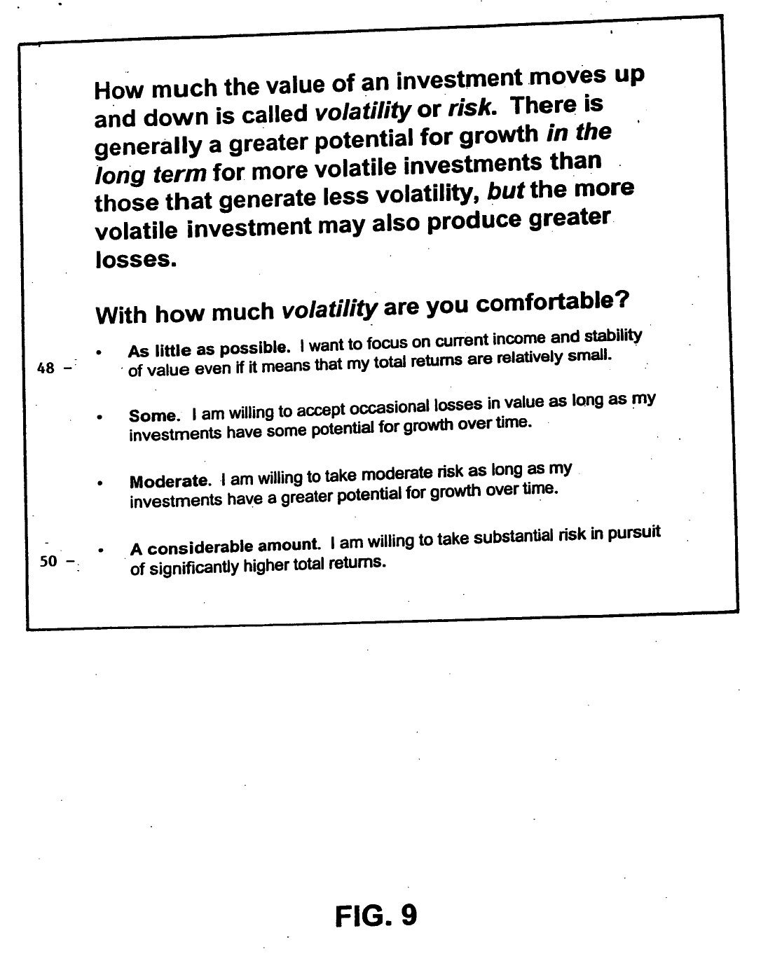

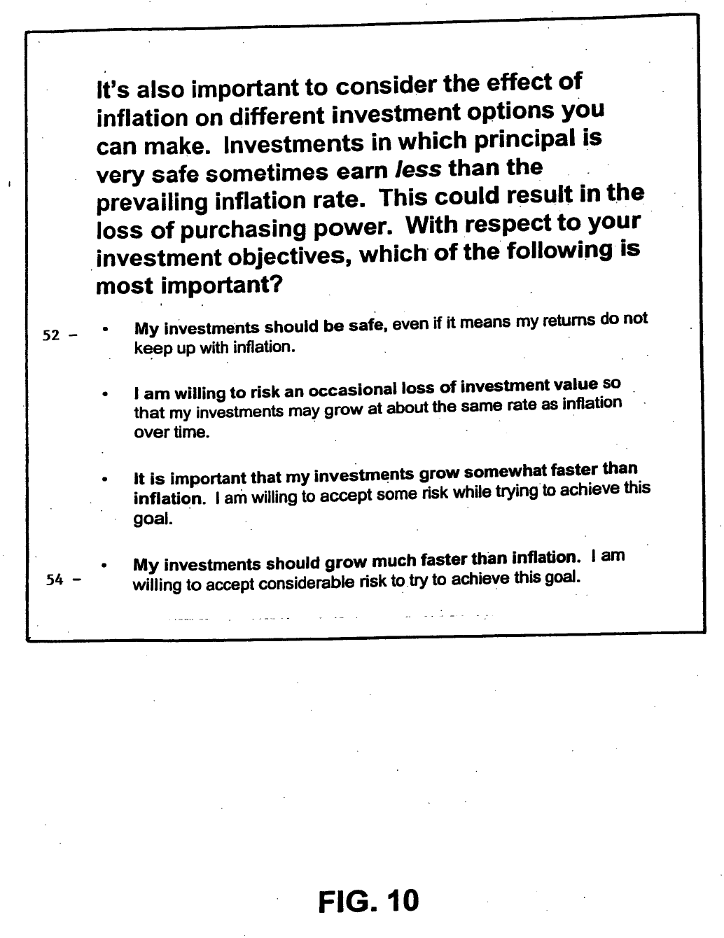

FIG. 9 illustrates a question similar to that of FIG. 8, but that is worded somewhat differently. The question of FIG. 9 focuses on investment volatility, and determines the customer's comfort level with various degrees of volatility by prompting the user to choose one of four options ranging from “As little as possible” 48 to “A considerable amount” 50. FIG. 10 illustrates a question that relates to the customer's preferences in light of the potential effects of inflation. The user can choose to protect the investments at the expense of not keeping up with inflation by choosing the option entitled “My investments should be safe” 52, or may alternatively choose to grow the investments at the expense of greater risk by choosing the option entitled “My investments should grow much faster than inflation” 54.

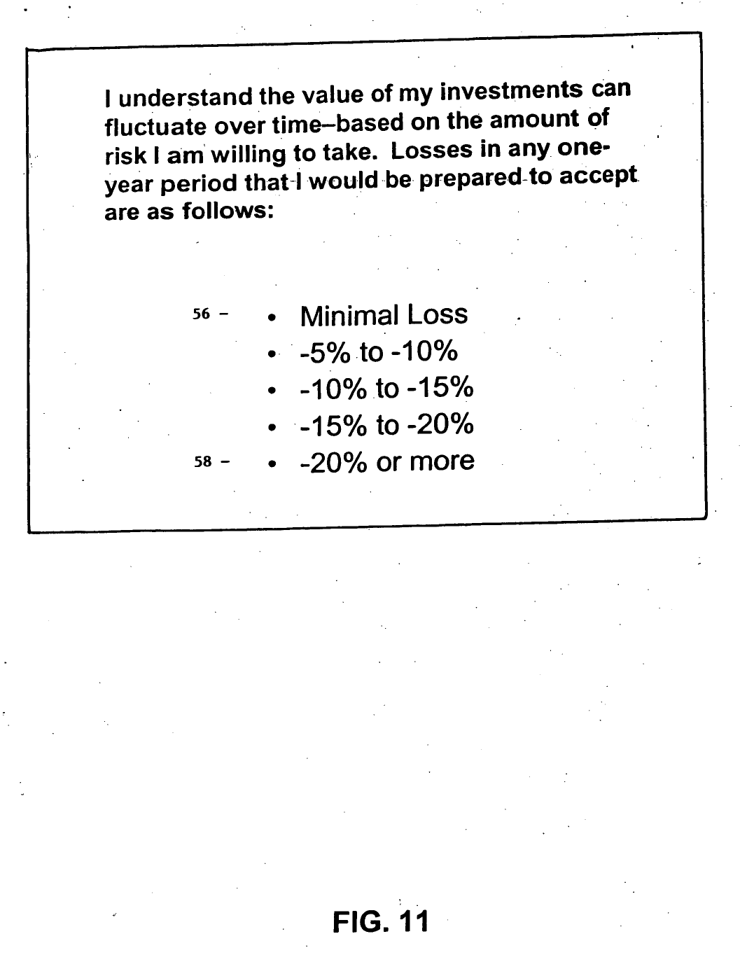

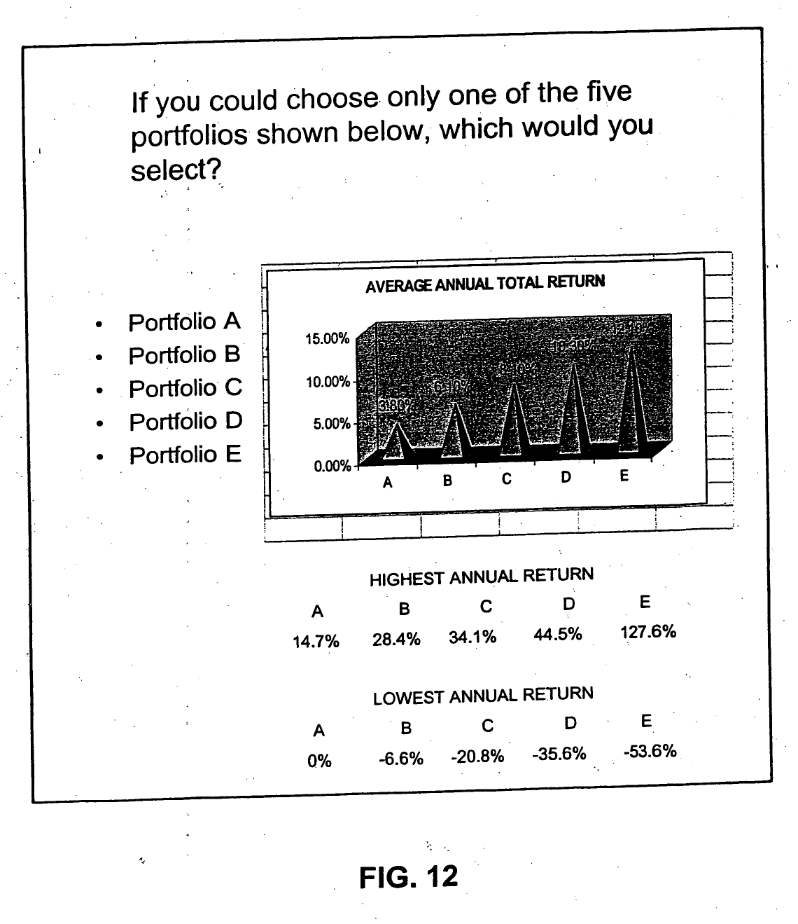

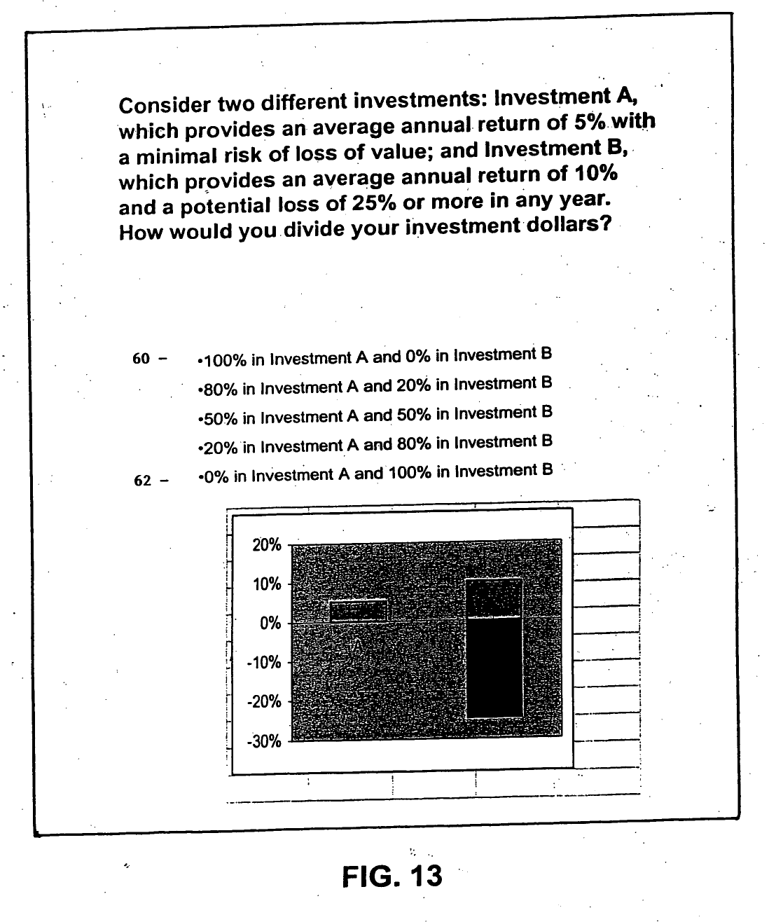

A question prompting a user to choose maximum loss preferences is illustrated in FIG. 11, wherein a user can choose a minimal loss option 56, a maximum loss option 58, or one of a plurality of loss options therebetween presenting various ranges of losses. More detailed questions are illustrated in FIGS. 12 and 13, wherein the user is presented with questions that reflect the nature of various sub-account investments. The question of FIG. 12 prompts the user to select a portfolio based on maximum annual return versus minimum annual return, wherein portfolio A is relatively conservative with a maximum possible annual return of 14.7% and a minimum possible annual return of 0%, and portfolio E is very aggressive with a maximum possible annual return of 127.6% and a minimum possible annual return of −53.6%. Portfolios B, C, and D are increasingly more aggressive than portfolio A but are less aggressive than portfolio E. FIG. 12 also illustrates a graphical representation of average annual total returns of each of the portfolios, wherein the graphical representation may be presented via the software interface to help inform the customer's decision.

The question of FIG. 13 prompts the user to select one of five investment allocation schemes, wherein a first allocation scheme 60 places all of the money in a low-return, low risk investment, and a second allocation scheme 62 places all of the money in a high-risk, high-return investment. A plurality of other investment allocation schemes divide the sub-account assets between the low return, low risk investment and the high return, high risk investment in varying degrees. Furthermore, a bar graph provides a visual comparison of the average annual returns and potential loss of two or more of the investment allocation schemes.

Based on the user's responses to the various risk preference questions, the program assigns the customer's risk tolerance to the closest one of five model investment portfolios: aggressive growth, growth, balanced, modest conservative, and conservative. The aggressive growth portfolio consists of data reflecting the monthly values of a portfolio of large-capitalization stocks since the early 1900s. The growth model portfolio is a customized historical blend (with annual reallocation) of 80% of the aggressive growth portfolio data and 20% of a blend of historic rates of medium- and long-term U.S. Treasury Notes and Bonds. The balanced model portfolio is a customized historical blend (with annual reallocation) of 60% of the aggressive growth portfolio data and 40% of the blend of historic rates of medium- and long-term U.S. Treasury Notes and Bonds. The modest conservative model portfolio is a customized historical blend (with annual reallocation) of 40% of the aggressive growth portfolio data and 60% of the blend of historic rates of medium- and long-term U.S. Treasury Notes and Bonds. The conservative model portfolio is a customized historical blend (with annual reallocation) of 20% of the aggressive growth portfolio data and 80% of the blend of historic rates of medium- and long-term U.S. Treasury Notes and Bonds.

Once a type of insurance policy is determined that is compatible with the customer's management and risk preferences, a funding premium is determined that meets the customer's expectations, as depicted in block 64 of FIG. 1. In determining the premium funding rate, a policy database is first established from which a benchmark policy can be derived that represents a blend of several insurance policies available on the market. The policy database generally is representative of the most common insurance policies from several insurance companies, and typically includes sufficient policy data to base any given benchmark policy on information from at least thirty policies currently available in the insurance market.

To develop the policy database, a volume of sales is determined from each of four classes of life insurance policies: universal life (UL), survivorship universal life (SUL), variable universal life (VUL), and survivorship variable universal life (SVUL). The volume of sales determination is based on raw insurance sales data for a given period, such as the prior year, wherein insurance companies and policies are chosen so that approximately 80% of the market share is represented in a list of identified carriers and products. Typically twenty to forty insurance companies will be represented. Policy parameters are gathered for each of the insurance carriers and products in order to create a database of composite data relating to various insurance expenses, including costs of insurance, premium loads, various elements of expense, Mortality and Expense, fund fees (for VULs), and other pricing elements.

The composite database is then refined using actuarial processes to eliminate extremes along a bell curve of results, such as statistical outliers. The resulting policy database is used to establish a benchmark policy for a particular type of policy chosen by the customer. The benchmark policy created from the policy database serves as a basis for illustrations and comparisons, as well as a starting point for policy performance analyses. The benchmark may be created, for example, by averaging all of the factors such as costs of insurance, premium loads, etc. from parameters of policies presenting similar risk characteristics. Each benchmark represents a blend of parameters from an array of currently-available policies, so particular new and in-force policies can be compared to the benchmark policy to determine, for example, extreme variances in policy expenses such as cost of insurance. The benchmark is updated periodically using data from currently sold policies, and is preferably updated annually.

Referring now to FIG. 14, a flowchart of steps involved in determining a funding premium that meets the expectations of the customer is illustrated. The program first factors the account value's asset allocation over the life of the policy into the analysis of the policy, as depicted in block 66 of FIG. 14. If the user has chosen to allocate sub-account assets in a manner similar to that of the growth model portfolio, for example, the program assigns an aggressive annual growth and high risk to 80% of the sub-account assets, and assigns a modest annual growth and low risk to 20% of the sub-account assets. The program also factors any changes in the asset allocation over the course of the policy. The user may choose, for example, to invest more aggressively during the first fifteen years of the policy and reallocate the policy assets thereafter according to a more conservative allocation.

The program then accounts for historic investment returns according to the asset allocation of the holdings, as depicted in block 68. In this step, the program applies actual historic return data to the asset allocation scheme to determine how much the principal is expected to grow. Regardless of the expected rate of return, the program increases the principal according to randomly generated interest rate patterns (UL/SUL) or randomly generated investment returns (VUL/SVUL).

The program then accounts for cost of insurance changes over the life of the policy, as depicted in block 70. While the insurance charge rate (expressed as monthly cost per 1,000 times the net amount of risk) will rise as the insured ages, the monthly payment required to satisfy the mathematical result of RATE times NET AMOUNT AT RISK will typically increase unless there is sufficient cash value to steadily reduce the net amount at risk. Consequently, the monthly insurance charge assessed in the policy will increase.

In an alternative approach to accounting for cost of insurance charges over the life of the policy, the program may factor changes in the cost of insurance associated with the trend of policy holders replacing older insurance policies with new insurance policies. As insurance policies get older, some policy holders will replace their older policy with a new policy to save money. The new policy may appear less expensive to the customer because the customer's health will have been newly-evaluated and thus the insurance company can illustrate a lower premium commensurate with the lower risk. As older policies are replaced with new policies, the insurance company may charge owners of the old policies increasingly higher premiums to account for the higher concentration of risk in that group of policies.

The program may account for this trend by automatically applying additional expense charges—beyond anticipated increases in the cost of insurance due to the traditional factors discussed above—to accounts that are more than a few years old to account for the increased cost of insurance.

The program then generates a confidence factor indicative of a probability of success that a policy will be sustained, as depicted in block 72. While the historic return information provides an indication of how much return may be generated by the policy sub-accounts, it does not indicate a probability that the investment will actually produce the average return. Because the premium required to maintain the policy depends substantially on the total account value, the timing of each monthly return is as important as what the average overall return may ultimately be. To address the likelihood of a sub-account generating sufficient income to maintain a policy for a pre-determined amount of time at a given premium level, the program generates the confidence factor. The method the program uses to generate the confidence factor depends on the type of policy. In particular, the method depends on whether the policy is a VUL/SVUL policy or a UL/SUL policy.

For VUL/SVUL policies, the program randomly generates investment portfolio returns from those that have actually occurred in the U.S. in the last 40 years. The randomly generated rates of return are used to produce from 300 to 1,000 trial illustration projections based on a user-specified premium, and tallies the number of trial illustrations that sustain to age 100 and those that don't. The percentage of trial illustrations that sustain-relative to the total number of trials is the confidence factor, or probability of success. For example, if 900 of 1,000 trial illustrations sustain to age 100, the confidence factor is 90%. In other words, 90% of similar investment strategies have been successful, or sustained until the customer reached the age of 100.

If the customer is not comfortable with the confidence factor generated by a particular premium, the premium may be adjusted. If the confidence factor for a premium of five hundred dollars is 60%, for example, the customer may choose to view the effect of increasing the premium. Increasing the premium to six hundred and fifty dollars may improve the confidence factor to 80%, which the customer may find satisfactory. Alternatively, the customer may specify a confidence factor with which he or she is comfortable and the program will calculate the approximate premium that will meet the specified confidence factor.

The program generates a confidence factor for UL and SUL policies differently than it does for VUL or SVUL policies. Traditional policy illustrations for UL and SUL policies are calculated with an interest rate that does not exceed the insurance company's current crediting rate. The company's crediting rate is related to the insurer's net return on portfolio earnings, however, and therefore generally changes, or undulates, as interest rates change in the general economy. Policy illustrations thus do not illustrate fluctuations in interest rates, which may be a source of error in the long-term projections.

To more accurately illustrate how a UL or SUL policy may perform under rising and falling interest rates, the program randomly undulates long-term interest rates according to actual undulation patterns that have occurred in the United States over the last forty years. These randomly undulating interest rate patterns are used to produce from 300 to 1,000 trial illustrations based on a specified premium. As in the method used with VUL and SVUL polices, the program tallies the number that sustain to age 100 and those that don't. The percentage of “sustains” relative to the total is the confidence factor.

The interest rate data used to determine long-term interest rate undulation patterns may be determined by projecting the entire treasury yield curve (from one to thirty years), then selecting a representative return from (currently) the 10-year U.S. Treasury Bond to derive a benchmark policy crediting rate. During different phases of an economic cycle, different duration bonds may be utilized to generate a benchmark rate. One skilled in the art, however, will recognize that data from various sources may be used to determine long-term interest rate undulation trends.

The program gives customers various options in determining the confidence factor. The customer has the option, for example, of setting the starting point of the undulation according to either the current credit rating of the policy or based on the random undulations. Furthermore, the program generates a report relating to the confidence factor that includes a probability of sustaining to a particular age of the insured, such as one hundred; an average death benefit of the policies that did sustain to that age; average death benefit of policies that sustained to another age, such as life expectancy; and an earliest age of likely lapse.

The user then indicates to the program whether the confidence factor is unacceptably low, as depicted in block 74. If the confidence factor is not unacceptably low, the process of determining a funding premium is done. Alternatively, if the confidence factor is not unacceptably low, the customer may desire to reduce the funding premium further to minimize premium payments.

If the confidence factor is unacceptably low, the program prompts the user to indicate an acceptable confidence factor, as depicted in block 76. The program then calculates the approximate premium corresponding to the acceptable confidence factor as depicted in block 78 and the process is done. If the confidence factor is unacceptably low, the program may also provide more detailed information about the trial illustrations. For example, the program may indicate a temporal distribution of the trial illustrations that do not sustain for the life of the policy to enable the user to determine when the earliest lapse occurs.

The program further enables the user to selectively modify the performance of the underlying investments of the trial illustrations and the life expectancy associated with the trial illustrations. The user may desire, for example, to decrement the historic data points by fifty to three hundred basis points in order to create more conservative trial illustrations if the user anticipates lower than historic returns due to an unfavorable market environment.

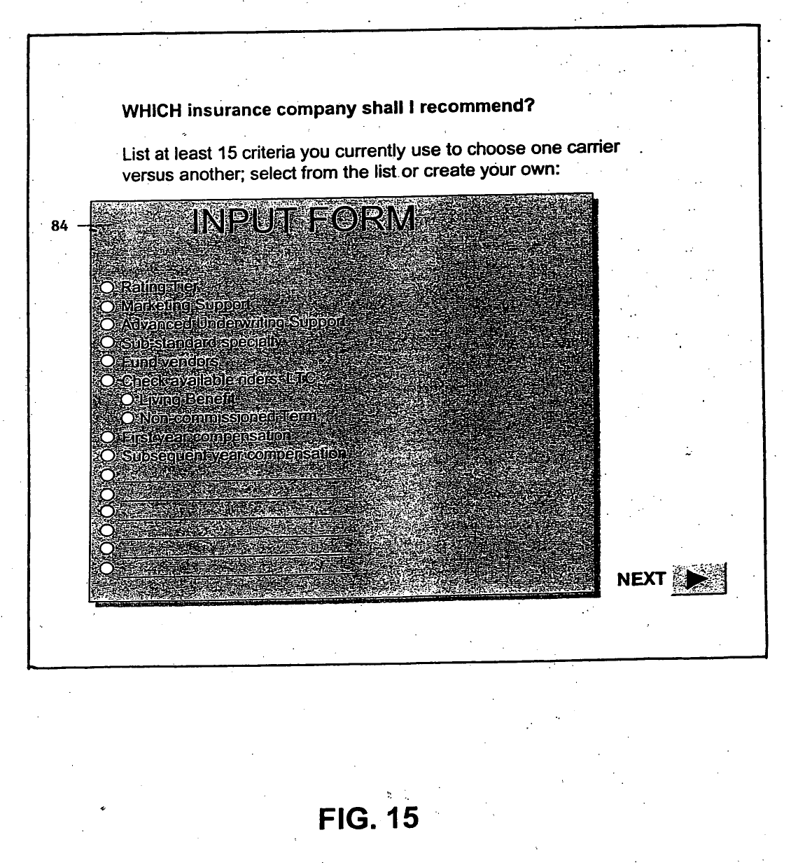

Once the funding premium has been determined, a particular life insurance company from which to purchase the policy is selected, as depicted in block 82 of FIG. 1. More particularly, the program assists the user in selecting a particular life insurance company from which to purchase the policy based on a number of criteria, at least a portion of which are specified by the user. FIGS. 15-20 illustrate portions of an exemplary questionnaire for taking the user through a process of choosing an insurance company. FIG. 15 illustrates an input form 84 presented to the user to begin the process, wherein the user is prompted to indicate fifteen or more criteria for use in selecting an insurance company, wherein at least a portion of the criteria are specified by the user. The user may indicate one or more criteria from a list of criteria, or may submit criteria that do not appear on the list.

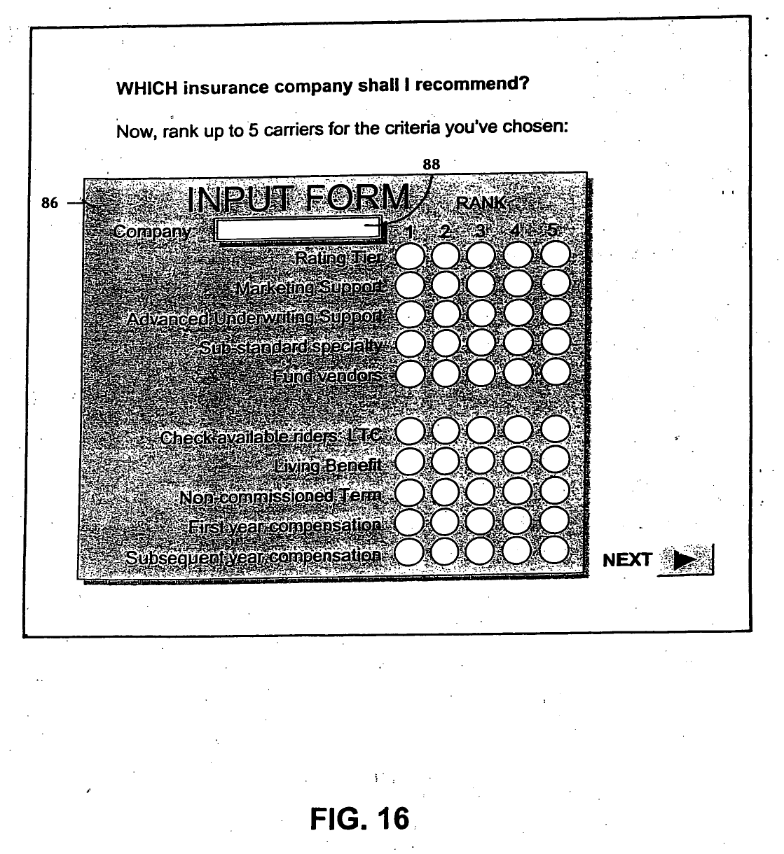

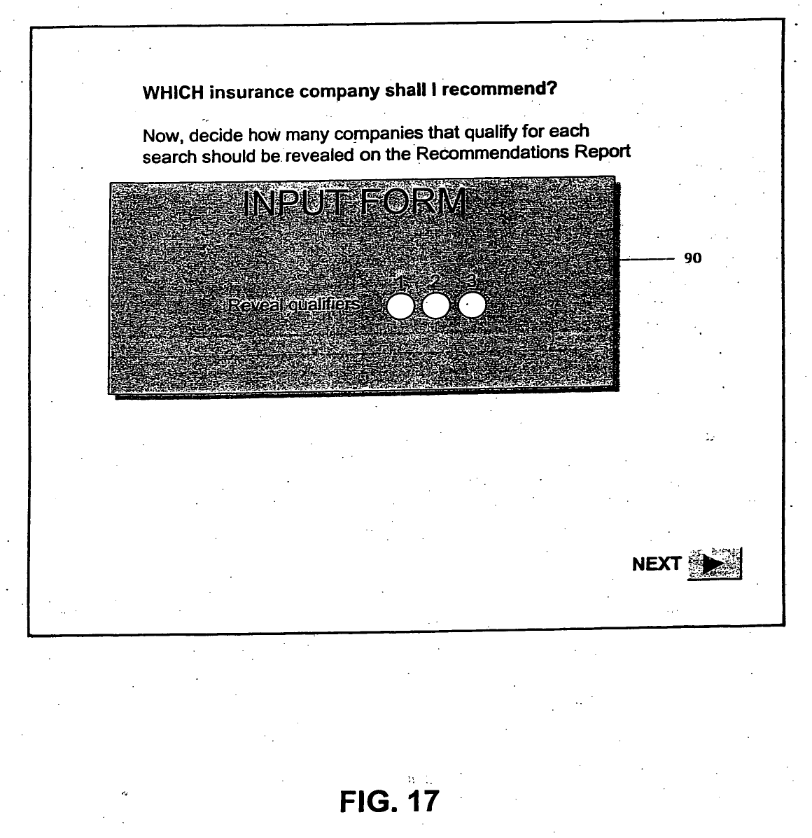

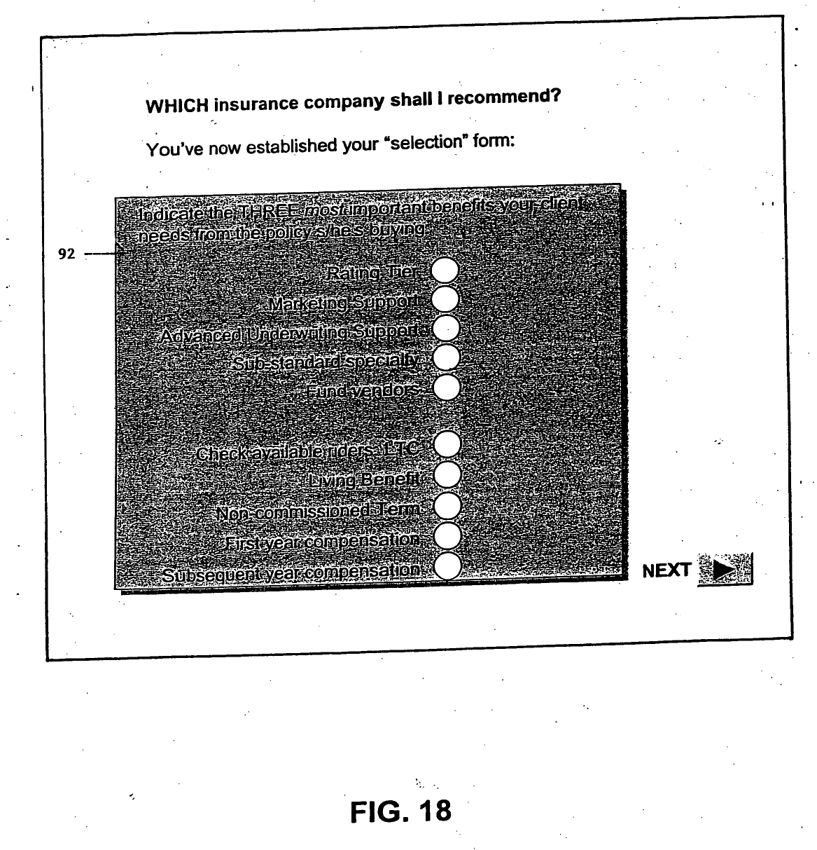

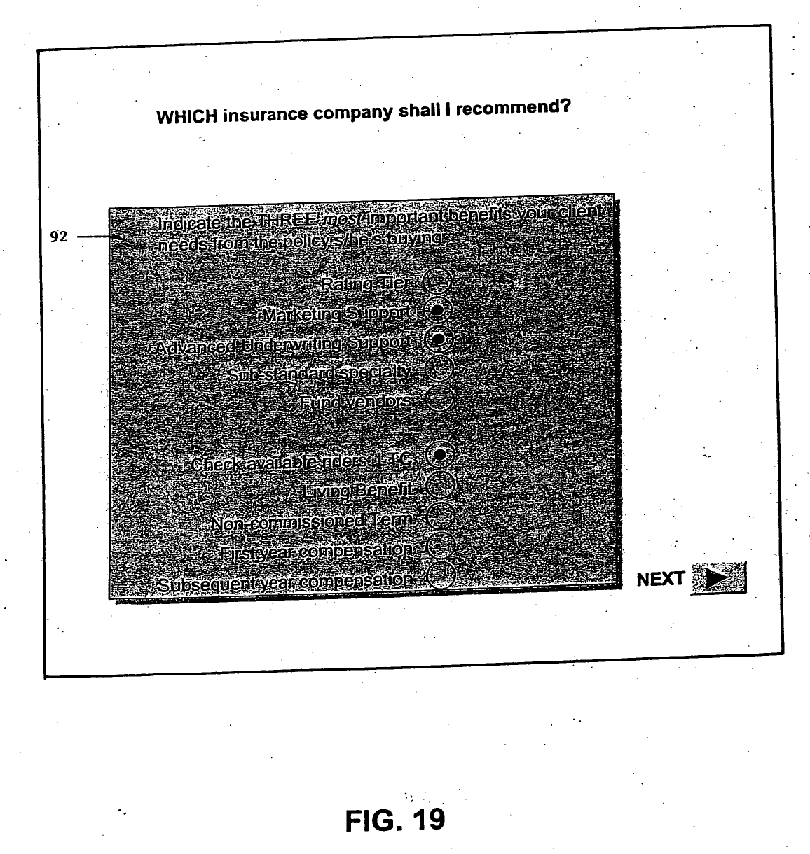

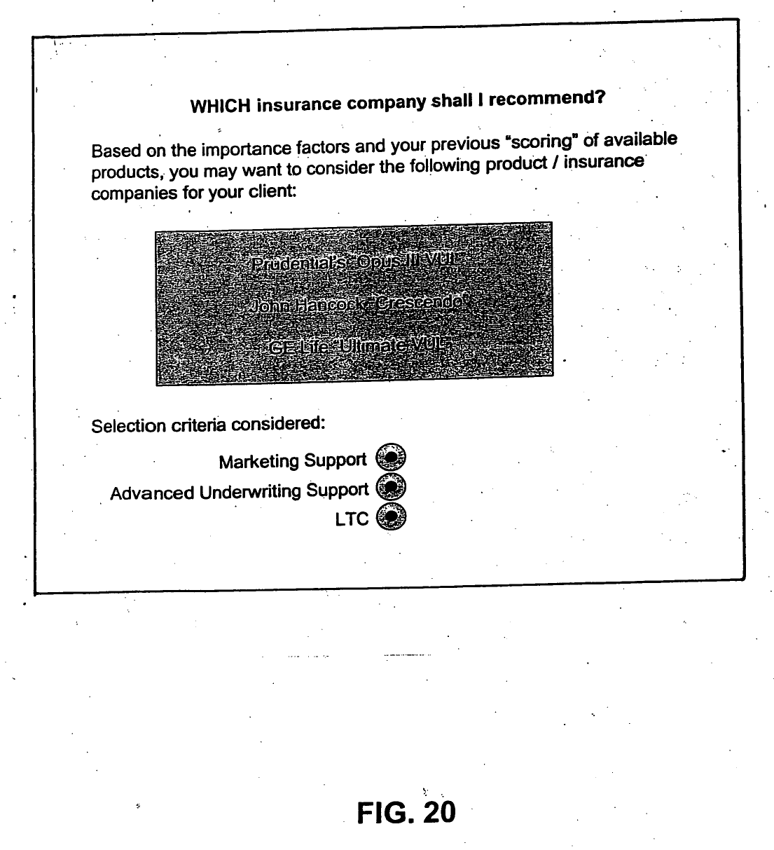

A form 86 illustrated in FIG. 16 enables a user to submit a name of a particular insurance company in a text field 88 and then rank the company from “1” to “5” in each of the criteria chosen in the form 84 of FIG. 15. The user fills out form 86 for each of a plurality of insurance companies. A form 90 illustrated in FIG. 17 enables the user to determine how many companies that qualify for each search should be revealed in a recommendations report. A form 92 illustrated in FIG. 18 enables the user to indicate which of the criteria are most important to the customer, wherein FIG. 19 illustrates the same form 92 with various criteria selected. An exemplary recommendations report is illustrated in FIG. 20, wherein a number of insurance companies and particular products are recommended.

Once a particular life insurance company and particular product have been selected, an investment plan for the sub-account assets is developed if the customer has chosen an investment-oriented policy such as a VUL or SVUL policy, as depicted in block 94 of FIG. 1. Developing the investment plan involves choosing from amongst an array of investment sub-accounts in a range of asset classes. If the user has chosen an investment scheme comprising a combination of aggressive and conservative investments, for example, the program identifies various aggressive investment options and various conservative investment options.

The program also assists the user in determining whether the customer can fund the policy with enough cash value to withdraw or borrow funds to supplement retirement income, as depicted in block 96 of FIG. 1. This step of the program projects availability of funds for use as supplemental retirement funds based on the projected premiums and expected future cash flow. Cash values can be withdrawn with no income tax up to the total amount of money put into the policy (tax basis). If additional cash values are to be removed from the policy, policy loans can be taken. Under current law, no taxes are assessed on policy loans (even when they exceed tax basis) as long as the policy remains in force until death. If the policy lapses before death, all borrowed funds in excess of the tax basis will become taxable as ordinary income in the year of the lapse.

To help prevent such lapses, the program illustrates supplemental retirement funding based on realistic assumptions. The program calculates a sufficient funding premium consistent with the number of years it will be paid (typically not beyond the retirement year) and calculates a potential annual withdrawal while keeping the policy in force. The program generates a confidence factor similar to the confidence factor described above, wherein the customer may choose to analyze the effect of increased premium payments if the confidence factor is unacceptably low. The program determines the supplemental retirement funding confidence factor in a manner substantially similar to that of the sustainability confidence factor described above, wherein the program generates a plurality of trial illustrations and reports a percentage of the trial illustrations that met the customer's expectations.

While the program has been described as assisting a user in assessing a new insurance policy, the program can also assist the user in determining whether an in-force insurance policy is performing according to the customer's expectations. More particularly, the program assists the user in determining a confidence factor relating to whether the customer's in-force insurance policy will sustain to a particular point in time, such as the insured's one hundredth birthday, according to known policy parameters such as the current funding premium, cost of insurance, and other policy expenses.

If the insured finds the in-force policy confidence factor to be unacceptably low, the program assists the user in determining what changes need to be made to generate a confidence factor that the insured finds acceptable. The customer may increase the premium payments, for example, or may lower the death benefit. Alternatively, the in-force policy may be replaced with a new policy. The program uses the same procedures set forth above to make this analysis. The program makes an objective ranking of the options available to the customer.

The program determines the in-force policy confidence factor in a manner similar to that of the sustainability confidence factor described above, wherein the program generates a plurality of trial illustrations and reports a percentage of the trial illustrations that met the customer's expectations. In determining the in-force policy confidence factor, however, the program assigns an initial value to the account value of the policy equal to the value of the insured's actual policy assets.

The program is capable of generating additional reports for life insurance policies that are held in trust. For example, the program will generate a customized investment and administrative policy statement for life insurance that sets out the objectives for the policy, how the underlying investments of the policy will be managed (for VUL policies), and details how the policy itself will be managed over time as variances in investment returns (for VUL policies) or interest rates (for UL policies) deviate from illustrated expectations. This report may be similar to an investment policy statement required under E.R.I.S.A. and, in a slightly different form, under the Uniform Prudent Investors Act.

The program also generates an investment and administrative policy statement for irrevocable life insurance trusts. This statement is identical to the customized investment and administrative policy statement for life insurance, except that it is specifically tailored to the needs of individual and institutional fiduciaries. The reports relating to life insurance policies held in trust may be generated in paper form, electronic form such as e-mail, HTML, or PDF, or both.

Having thus described the preferred embodiment of the invention, what is claimed as new and desired to be protected by Letters Patent includes the following:

1. A method of assessing the sustainability of a permanent life insurance policy, the method comprising the steps of:
(a) creating a benchmark policy using policy parameters from a plurality of similar insurance policies, wherein the policy parameters include policy expenses and fees;
(b) generating a plurality of trial illustrations using parameters of the benchmark policy, a user-specified premium amount, and performance information from a plurality of actual investment portfolios; and
(c) calculating a percentage of the trial illustrations that sustain through a pre-determined period of time.

2. The method as set forth in claim 1, wherein step (a) further comprises the steps of:
(a1) creating a policy database including policy parameters from a plurality of insurance policies currently available on the market; and
(a2) creating the benchmark policy by averaging policy parameters of a plurality of insurance policies from the policy database presenting similar risk characteristics as a user-specified investment scheme.

3. The method as set forth in claim 1, wherein step (b) further comprises the step of:
(b1) generating from three hundred to one thousand trial illustrations using investment performance randomly generated from a model investment portfolio chosen by the user, based on the most recent forty-year (480 month) period.

4. The method as set forth in claim 3, wherein step (b) further comprises the step of:
(b2) generating a series of randomly selected investment returns to build a hypothetical account value for each trial illustration.

5. The method as set forth in claim 1, wherein step (b) further comprises the step of:
(b3) generating the plurality of trial illustrations using investment return information from a plurality of randomly-selected actual investment portfolios presenting similar risk characteristics as a user-specified investment scheme.

6. The method as set forth in claim 1, wherein step (b) further comprises the step of:
(b4) generating the performance information by creating randomly undulating interest rates according to actual undulation patterns of one or more actual interest rates.

7. The method as set forth in claim 6, further comprising the step of:
(d) enabling a user to determine a starting point of the undulating interest rates.

8. The method as set forth in claim 1, further comprising the step of:
(e) generating a second plurality of trial illustrations using a second user-specified premium amount if the percentage of trial illustrations that sustain through the pre-determined period of time is unacceptable to the user.

9. The method as set forth in claim 1, further comprising the steps of:
(f) creating a second benchmark policy by averaging policy parameters of a plurality of insurance policies that present risk characteristics similar to a user-specified investment scheme; and
(g) generating a second plurality of trial illustrations using parameters of the second benchmark policy, a user-specified premium amount, and performance information from a second plurality of randomly-selected actual portfolios presenting risk characteristics similar to the user-specified investment scheme, and calculating a percentage of the trial returns that sustain through an anticipated life of the policy.

10. The method as set forth in claim 9, step (f) further comprising the step of:
(f1) selecting the user-specified investment scheme such that the second benchmark policy presents greater risk than the first benchmark policy.

11. The method as set forth in claim 10, step (f) further comprising the step of:
(f2) performing step (f1) if a user is willing to accept a lower percentage of trial runs that sustain through the pre-determined period of time.

12. The method as set forth in claim 9, step (f) further comprising the step of:
(f3) selecting the user-specified investment scheme such that the second benchmark policy presents lower risk than the first benchmark policy.

13. The method as set forth in claim 12, step (f) further comprising the step of:
(f4) performing step (f3) if the percentage of trial returns that sustain through the pre-determined period of time is unacceptably high to the user.

14. The method as set forth in claim 1, wherein step (c) further comprises the step of:
(c1) calculating the percentage of trial illustrations that sustain through the predetermined period of time by periodically adding a premium amount and an investment income amount to each trial illustration, periodically debiting a cost of insurance amount and an expense amount from each trial illustration, and determining a percentage of trial illustrations with positive balances throughout the predetermined period of time.

15. The method as set forth in claim 1, further comprising the steps of:
(h) creating a plurality of model policy sub-account investment portfolios with varying degrees of risk;
(i) receiving risk preference information from a user;
(j) assigning the user a sub-account investment portfolio that most closely corresponds to the person's risk preference information; and
(k) generating the performance information from the sub-account investment portfolio assigned to the user.

16. The method as set forth in claim 15, step (h) further comprising the steps of:
(h1) creating a first model investment sub-account portfolio including only data reflecting the monthly values of a portfolio of large-capitalization stocks in the United States over at least a forty-year period;
(h2) creating a second model investment sub-account portfolio comprising 80% data reflecting the monthly values of a portfolio of large-capitalization stocks in the United States over at least a forty-year period and 20% data reflecting a blend of historic rates of medium- and long-term U.S. Treasury Notes and Bonds;
(h3) creating a third model investment sub-account portfolio comprising 60% data reflecting the monthly values of a portfolio of large-capitalization stocks in the United States over at least a forty-year period and 40% data reflecting a blend of historic rates of medium- and long-term U.S. Treasury Notes and Bonds;
(h4) creating a fourth model investment sub-account portfolio comprising 40% data reflecting the monthly values of a portfolio of large-capitalization stocks in the United States over at least a forty-year period and 60% data reflecting a blend of historic rates of medium- and long-term U.S. Treasury Notes and Bonds; and
(h5) creating a fifth model investment sub-account portfolio comprising 20% data reflecting the monthly values of a portfolio of large-capitalization stocks in the United States over at least a forty-year period and 80% data reflecting a blend of historic rates of medium- and long-term U.S. Treasury Notes and Bonds.

17. The method as set forth in claim 1, further comprising the step of:
(l) indicating a temporal distribution of trial illustrations that do not sustain through the pre-determined period of time.

18. The method as set forth in claim 1, further comprising the step of:
(m) modifying the performance information so that returns are reduced by 50 to 300 basis points and generating the plurality of trial policies based on the modified performance information.

19. The method as set forth in claim 1, further comprising the step of:
(n) enabling a user to select the pre-determined period of time.

20. A method of assessing the sustainability of a proposed permanent life insurance policy, the method comprising the steps of:
(a) determining a user-specified investment allocation scheme;
(b) creating a benchmark policy by averaging policy parameters from a plurality of insurance policies that present a risk similar to the user-specified investment allocation scheme, wherein the policy parameters include policy expenses;
(c) generating a plurality of trial illustrations using parameters of the benchmark policy, a user-specified premium amount, and hypothetical performance information from forty-year random historical investment return data in up to one thousand trial illustrations, and calculating a percentage of the trial illustrations that sustain through a pre-determined period of time by periodically adding a premium amount and an investment income amount to each trial illustration and periodically debiting a cost of insurance amount and an expense amount from each trial illustration;
(d) determining a first percentage of trial illustrations with positive balances throughout the predetermined period of time; and
(e) determining a premium amount corresponding to a user-specified alternative percentage of trial illustrations with positive balances throughout the predetermined period of time if the first percentage is unacceptable to the user.

21. The method as set forth in claim 20, further comprising the steps of:
(f) creating a second benchmark policy by averaging policy parameters of a plurality of insurance policies that present risk characteristics similar to a second user-specified investment scheme; and
(g) generating a second plurality of trial illustrations using parameters of the second benchmark policy, a user-specified premium amount, and performance information from a plurality of randomly-selected actual portfolios, and calculating a percentage of the trial returns that sustain through an anticipated life of the policy.

22. A method of assessing the sustainability of an in-force permanent life insurance policy, the method comprising the steps of:
(a) determining an asset value and an investment allocation scheme of an in-force permanent life insurance policy;
(b) generating a plurality of trial illustrations using expense and premium information from the in-force policy, the asset value of the in-force policy, and performance information from a plurality of actual investment portfolios presenting investment allocation schemes similar to that of the in-force policy; and
(c) calculating a percentage of the trial illustrations that sustain through a pre-determined period of time.

23. The method as set forth in claim 22, further comprising the step of:
(d) determining a premium amount corresponding to a user-specified alternative percentage of trial illustrations that sustain through the. predetermined period of time if the first percentage is unacceptable to the user.

24. The method as set forth in claim 22, further comprising the step of:
(e) generating a second plurality of trial returns using a user-specified premium amount that is different than the premium amount of the in-force policy if the percentage of trial illustrations that sustain through the a pre-determined period of time is unacceptable to a user.

25. The method as set forth in claim 22, further comprising the steps of:
(f) creating a benchmark policy by averaging policy parameters of a plurality of insurance policies that present risk characteristics similar to a user-specified investment scheme; and
(g) generating a second plurality of trial illustrations using parameters of the benchmark policy, a user-specified premium amount, and performance information from a plurality of randomly-selected actual portfolios, and calculating a second percentage of the trial returns that sustain through the pre-determined period of time.

26. The method as set forth in claim 25, further comprising the step of:
(h) selecting the user-specified investment scheme such that the second benchmark policy presents greater risk than the first benchmark policy.

27. The method as set forth in claim 26, further comprising the step of:
(i) performing step (j) if a user is willing to accept a lower percentage of trial runs that sustain through the a pre-determined period of time.

28. The method as set forth in claim 25, further comprising the step of:
selecting the user-specified investment scheme such that the second benchmark policy presents lower risk than the in-force policy.

29. The method as set forth in claim 28, further comprising the step of:
(k) performing step (i) if the percentage of trial returns that sustain through the pre-determined period of time is unacceptably high to the user.

30. The method as set forth in claim 22, further comprising the step of: (b1) in generating the plurality of trial illustrations, increasing the cost of insurance according to an age of the in-force policy.

31. The method as set forth in claim 22, further comprising the step of:
(b2) in generating the plurality of trial illustrations, increasing the cost of insurance according to an age of the policy and an increased concentration of risk due to assumed adverse selection.

32. The method as set forth in claim 31, wherein adverse selection occurs when policy holders willingly terminate a first policy in favor of a newly-issued contract, and wherein policy lapses result in an increased concentration of adverse risk due to an increase concentration of policy holders with unfavorable health conditions.

33. The method as set forth in claim 22, wherein step (c) further comprises the step of:
(c1) calculating the percentage of trial illustrations that sustain through the predetermined period of time by periodically adding a premium amount and an investment income amount to each trial illustration, periodically debiting a cost of insurance amount and an expense amount from each trial illustration, and determining a percentage of trial illustrations with positive balances throughout the predetermined period of time.

34. A method of assisting a customer in choosing an appropriate premium amount for a permanent life insurance policy, the method comprising the steps of:
(a) receiving from the customer a preferred policy premium amount;
(b) determining a first confidence factor indicating a likelihood that the life insurance policy will sustain through a life of the policy for the preferred premium amount;
(c) receiving from the customer a second confidence factor if the first confidence factor is not acceptable to the user; and
(d) determining a second policy premium amount corresponding to the second confidence factor.

35. The method as set forth in claim 34, further comprising the steps of:
(e) receiving from the customer a projected cash withdrawal amount to be withdrawn from the policy in the future; and
(f) determining a third confidence factor indicating a likelihood that the life insurance policy will sustain through a life of the policy for the second policy premium amount and the cash withdrawal amount.

36. The method as set forth in claim 35, further comprising the steps of:
(g) receiving from the customer a fourth confidence factor if the third confidence factor is not acceptable to the user; and
(h) determining a second cash withdrawal amount corresponding to the second confidence factor.

37. A computer-readable medium encoded with a computer program for enabling a computer to assess the sustainability of a permanent life insurance policy, the program comprising code segments for:
(a) determining an amount of insurance commensurate with a person's needs and expectations;
(b) determining a type of insurance policy that is compatible with the person's risk and management preferences;
(c) determining a funding premium that meets the person's expectations;
(d) selecting a particular life insurance company from which to purchase the life insurance policy;
(e) determining an investment strategy for a policy sub-account; and
(f) determining whether the person can fund the policy with sufficient cash premium to withdraw or borrow funds to supplement retirement income.

38. The computer-readable medium as set forth in claim 37, further comprising code segments for:
(g) creating a benchmark policy by averaging policy parameters from a plurality of similar insurance policies, wherein the policy parameters include policy expenses; and
(h) generating a plurality of trial illustrations using the parameters of the benchmark policy, a user-specified premium amount, and performance information from a plurality of randomly-selected actual portfolios, and calculating a percentage of the trial returns that sustain through the pre-determined period of time.

39. The computer-readable medium as set forth in claim 38, further comprising a code segment for:
(h1) in generating the plurality of trial illustrations, increasing the cost of insurance according to the age of the policy from its inception.

40. The computer-readable medium as set forth in claim 38, further comprising a code segment for:
(h2) in generating the plurality of trial illustrations, increasing the cost of insurance according to an age of the policy and an increased concentration of risk due to policy owners abandoning policies.

41. The computer-readable medium as set forth in claim 38, further comprising code segments for:
(i) generating a customizable report that includes a graphic illustration, wherein the report relates to a topic selected from the group consisting of the amount of insurance, the type of insurance, funding premium, a particular life insurance company and policy, the investment strategy for the sub-account, and supplemental retirement income information.

42. The computer-readable medium as set forth in claim 38, further comprising code segments for:
(d1) receiving a plurality of criteria the person uses to choose an insurance company;
(d2) enabling the person to indicate a degree of importance of each of the criteria; and
(d3) generating a report that contains one or more insurance companies chosen according to the criteria and the degree of importance of each of the criteria.

43. The computer-readable medium as set forth in claim 37, further comprising a code segment for:
(b1) determining a degree of control the person desires to have over policy asset investment decisions by determining an amount of investment experience of the person, the person's desire to control how policy assets are invested, the person's desire to protect policy assets from a failure of the company, and a length of time the person intends to maintain the policy.

44. The computer-readable medium as set forth in claim 37, further comprising a code segment for:
(b2) determining the person's risk preference by determining the person's preferences relating to preservation and growth of the policy assets, investment volatility, asset growth in relation to inflation, and maximum acceptable losses.
